(19) United States
(12) Patent Application Publication
(10) Pub. No.: US 2014/0056348 A1
(43) Pub. Date: Feb. 27, 2014

(54) METHODS AND DEVICE FOR RECONSTRUCTING AND CODING AN IMAGE BLOCK

(71) Applicants: Edouard Francois, Bourg des Comptes (FR); Dominique Thoreau, Cesson Sevigne (FR); Fabien Racape, Berlin (DE); Aurelie Martin, Paris (FR)

(72) Inventors: Edouard Francois, Bourg des Comptes (FR); Dominique Thoreau, Cesson Sevigne (FR); Fabien Racape, Berlin (DE); Aurelie Martin, Paris (FR)

(73) Assignee: THOMSON LICENSING, Issy de Moulineaux (FR)

(21) Appl. No.: 14/004,732

(22) PCT Filed: Mar. 8, 2012
(86) PCT No.: PCT/EP2012/053978

§ 371 Date: Oct. 23, 2013

(30) Foreign Application Priority Data
Mar. 14, 2011 (FR) 1152044

(51) Int. Cl. H04N 7/32

(52) U.S. Cl. CPC H04N 19/00569
USPC 375/240.12

(57) ABSTRACT

A method for reconstruction of a current block predicted from at least one reference block is described. The method comprises the steps for:
decoding at least one weighted prediction parameter, called an explicit parameter, from coded data,
calculating at least one weighted prediction parameter, called an implicit parameter, from a first causal neighbouring area of the current block and a first corresponding neighbouring area of the reference block,
calculating a first distortion resulting from the prediction of a second causal neighbouring area of the current block with the explicit parameter and a second distortion resulting from the prediction of said second causal neighbouring area with the implicit parameter,
comparing the first and second distortions,
selecting a parameter between the explicit parameter and the implicit parameter according to the result of the comparison, and
reconstructing the current block using the selected parameter.

### 1. DOMAIN OF THE INVENTION

The invention relates to the general domain of image coding.

More specifically, the invention relates to a method for coding a block of an image and a corresponding method for reconstructing such a block.

### 2. PRIOR ART

The majority of coding/decoding methods use prediction between images (inter-image prediction) or prediction in the image (intra-image prediction). Such a prediction is used to improve the compression of a sequence of images. It consists in generating a prediction image for a current image having to be coded and in coding the difference between the current image and the prediction image, also called residual image. The more the image is correlated with the current image, the lower is the number of bits required to code the current image and therefore the more effective is the compression. However, the prediction loses its efficiency when there is a variation in luminosity between the images of the sequence or inside an image. Such a luminosity variation is for example due to a modification of illumination, to fade effects, to flashes, etc.

Methods for coding/decoding image sequences are known that take into account an overall variation in luminosity. Hence, within the framework of the standard H.264 described in the document ISO/IEC 14496-10, it is known to use a weighted prediction method in order to improve the compression in the case of a variation in luminosity. The weighted prediction parameters are explicitly transmitted per image slice. The illumination correction is applied identically for all of the blocks of the slice. According to this method, it is possible to transmit weighted prediction parameters for each block. Such parameters are called explicit parameters.

It is also known to such weighted prediction parameters for a current block from a causal neighbouring area of the block, i.e. comprising coded/reconstructed pixels before the current block. This method is less costly in terms of bitrate as the weighted prediction parameters are not coded explicitly in the stream. Such parameters are called implicit parameters.

The efficiency of the two methods, i.e. that using parameters explicitly coded in the stream and that using implicit parameters strongly depends on the content processed specifically on the spatial-temporal local variations and decoding configurations such as the bitrate targeted.

### SUMMARY OF THE INVENTION

The purpose of the invention is to overcome at least one of the disadvantages of the prior art.

The invention relates to a method for reconstruction of a current block of an image predicted from at least one reference block, the current block being in the form of coded data. The method for reconstruction comprises steps for:
decoding at least one weighted prediction parameter, called an explicit parameter, from coded data,
calculating at least one weighted prediction parameter, called an implicit parameter, from a first causal neighbouring area of the current block and the first neighbouring area corresponding to the reference block,
calculating a first distortion resulting from the prediction of a second causal neighbouring area of the current block with the explicit parameter and a second distortion resulting from the prediction of the second causal neighbouring area with the implicit parameter,
comparing the first and second distortions,
selecting a parameter between the explicit parameter and the implicit parameter according to the result of the comparison, and
   reconstructing the current block using the selected parameter.

Advantageously, the method for reconstruction according to the invention enables a permanent adaptation to the local variations of signal properties, in particular illumination variations. The limits of the explicit coding of illumination variation parameters can thus be compensated. Indeed they can be locally sub-optimal due to the search for the best bitrate distortion compromise. The placing into competition of a second implicit model enables this fault to be corrected in certain cases, without introducing an extra coding cost.

According to an aspect of the invention, the first distortion respectively the second distortion is calculated according to the following steps for:
predicting the second neighbouring area of the current block using a second corresponding neighbouring area of the reference block while taking account of the explicit prediction parameter respectively of the implicit prediction parameter, and
calculating the first distortion respectively the second distortion between the prediction and the second neighbouring area of the current block.

According to a particular characteristic of the invention, the first causal neighbouring area is different from the second causal neighbouring area. The term “different” does not signify that the two neighbouring areas are necessarily separate. The selection of parameters on a second causal neighbouring area different from the first causal neighbouring area enables the advantage that the implicit model calculated on the first causal neighbour area would have with respect to the explicit model for which the parameters are assigned not to the first causal neighbouring area but to the current block.

According to another particular characteristic of the invention, the first causal neighbouring area and the second causal neighbouring area are separate.

Advantageously, the first causal neighbouring area is determined while selecting pixels belonging to neighbouring blocks of the current block for each of which the explicit parameter decoded is similar to the explicit parameter of the current block. A decoded explicit parameter is similar to the explicit parameter of the current block when the norm of the difference between the explicit parameters is less than a threshold value.

According to a particular characteristic of the invention, the reference block belongs to the same image as the current block.

According to a variant, the reference block belongs to an image different from the image to which the current block belongs.

The invention also relates to a method for coding a current block of an image sequence by prediction using at least one reference block. The coding method comprises the following steps for:
calculating at least one weighted prediction parameter, called the explicit parameter, using the current block and the reference block,
calculating at least one weighted prediction parameter, called an implicit parameter, from a first causal neighbouring area of the current block and the first neighbouring area corresponding to the reference block,
calculating a first distortion resulting from the prediction of a second causal neighbouring area of the current block with the explicit parameter and a second distortion resulting from the prediction of the second causal neighbouring area with the implicit parameter,
comparing the first and second distortions, and
selecting a parameter between the explicit parameter and the implicit parameter according to the result of the comparison, and
coding the current block using the selected parameter.

Advantageously, the explicit parameter is systematically coded.

### 3. LIST OF FIGURES

The invention will be better understood and illustrated by means of embodiments and advantageous implementations, by no means limiting, with reference to the figures in the appendix, wherein:

FIG. 1 shows a current image Ic to which belongs a current block Bc to coded (respectively to be reconstructed) and a reference image Ir,

FIG. 2 shows a method for reconstruction of an image block according to the invention,

FIG. 3 shows a method for coding of an image block according to the invention,

FIG. 4 shows an image block coding device according to the invention, and

FIG. 5 shows a device for decoding a stream of coded data for the reconstruction of an image block according to the invention.

### 4. DETAILED DESCRIPTION OF THE INVENTION

It is to be understood that the present principles may be implemented in various forms of hardware, software, firmware, special purpose processors, or a combination thereof. Preferably, the present principles may be implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

The invention may be realized on any electronic device comprising coding or decoding means correspondingly adapted. For instance, the invention may be realized in a television, a mobile videophone, a personal computer, a digital video camera, a navigation system or a car video system.

An image sequence is a series of several images. Each image comprises pixels or image points, with each of which is associated at least one item of image data. An item of image data is for example an item of luminance data or an item of chrominance data.

The term “motion data” is to be understood in the widest sense. It comprises the motion vectors and possibly the reference image indexes enabling a reference image to be identified in the image sequence. It can also comprise an item of information indicating the interpolation type used to determine the prediction block. In fact, in the case where the motion vector associated with a block Bc does not have integer coordinates, the image data must be interpolated in the reference image Iref to determine the prediction block. The motion data associated with a block are generally calculated by a motion estimation method, for example by block matching. However, the invention is in no way limited by the method enabling a motion vector to be associated with a block.

The term “residual data” signifies data obtained after extraction of other data. The extraction is generally a subtraction pixel by pixel of prediction data from source data. However, the extraction is more general and comprises notably a weighted subtraction. The term “residual data” is synonymous with the term “residue”. A residual block is a block of pixels with which residual data is associated.

The term “prediction data” signifies data used to predict other data. A prediction block is a block of pixels with which prediction data is associated.

A prediction block is obtained from a block or several blocks of the same image as the image to which belongs the block that it predicts (spatial prediction or intra-image prediction) or from one (mono-directional prediction) or several blocks (bi-directional or bi-predicted prediction) of a different image (temporal prediction or inter-image prediction) of the image to which the block that it predicts belongs.

The term “prediction mode” specifies the way in which the block is coded. Among the prediction modes, there is the INTRA mode that corresponds to a spatial prediction and the INTER mode that corresponds to a temporal prediction. The prediction mode can specify the way in which the block is partitioned to be coded. Thus, the 8×8 INTER prediction mode associated with a block of size 16×16 signifies that the 16×16 block is partitioned into 4 8×8 blocks and predicted by temporal prediction.

The term “reconstructed data” signifies data obtained after merging of residual data with prediction data. The merging is generally a sum pixel by pixel of prediction data to residual data. However, merging is more general and comprises notably the weighted sum. A reconstructed block is a block of pixels with which reconstructed image data is associated.

A neighbouring block or neighbouring template of a current block is a block respectively a template situated in a more or less large neighbourhood of the current block but not necessarily adjacent to this current block.

The term coding is to be taken in the widest sense. The coding can possibly but not necessarily comprise the transformation and/or the quantization of image data.

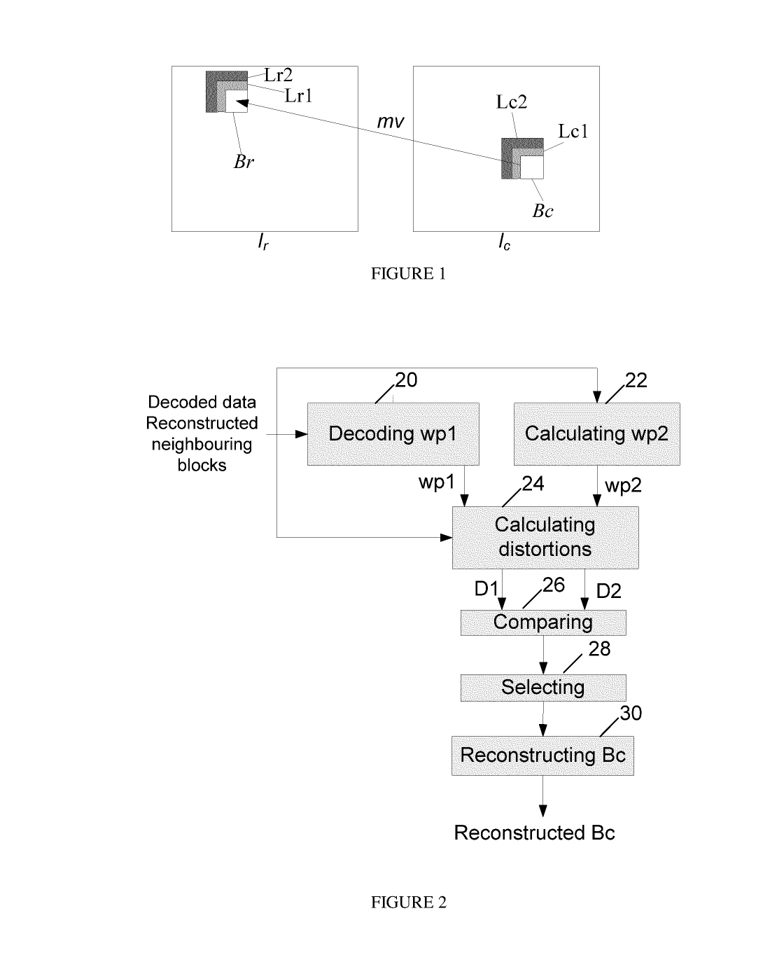

On FIG. 1 is shown a current image Ic in which is located a current block Bc with which is associated a first causal neighbouring area Lc1 and a second causal neighbouring area Lc2. With the current block Bc is associated a reference block Br of a reference image Ir (temporal prediction or INTER). To this reference block Br is associated a first neighbouring area Lr1 corresponding to the neighbouring area Lc1 of Bc and a second neighbouring area Lr2 corresponding to the neighbouring area Lc2 of Bc. In this figure, the reference block Br is identified using a motion vector my associated with the current block. The neighbouring areas Lr1 and Lr2 occupy the same positions with respect to Br as the neighbouring areas Lc1 and Lc2 with respect to Bc. According to a variant not shown the reference block Br belongs to the same image as the current block (spatial prediction or INTRA).

In order to not select a priori one prediction method over another, the method for reconstructing (respectively for coding) according to the invention enables the use of the two types of weighted prediction parameters, i.e. implicit parameters and explicit parameters. In addition, the method for reconstruction (respectively for coding) advantageously enables not having to signal in the stream of coded data the type of parameter used. The selection of one or other type of weighted prediction parameters is carried out both via the coding method and via the reconstruction method according to a causal neighbouring area of the current block to be reconstructed (respectively to be coded) and of the corresponding neighbouring area associated with a reference block.

Hereafter the term explicit parameter is synonymous with the term explicit weighted prediction parameter and the term implicit parameter is synonymous with implicit weighted prediction parameter.

In reference to FIG. 2, the invention relates to a method for reconstruction of a current block Bc predicted from at least one reference block Br, the current block being in the form of coded data. According to the invention, the reference block Br belongs to a reference image Ir other than the current image Ic or to the current image Ic.

During a step 20, a weighted prediction parameter wp1, called the explicit parameter, is decoded from coded data. The decoding implements for example the H.264 standard described in the document ISO/IEC 14496-10. However the invention is in no way limited by the method for coding the explicit parameter wp1.

During a step 22, a weighted prediction parameter wp2, called the implicit parameter, is calculated from a first causal neighbouring area Lc1 of the current block Bc and a first corresponding neighbouring area Lr1 of the reference block Br. This parameter is determined according to a known method for example according to that described in the patent application WO/2007/094792 or according to the method described in the patent application WO/2010/086393. As a simple example, wp2 is equal to the average of luminance values associated with the pixels of Lc1 divided by the average of luminance values associated with the pixels of Lr1.

According to a particular embodiment, the pixels of the first neighbouring area Lc1 (and consequently those of Lr1) are determined from the explicit parameter wp1. Note for example wp1_c the explicit parameter of the current block. Only the pixels of neighbouring blocks of Bc for which the explicit parameters wp1 are similar to that wp1_c of the current block are taken into account in Lc1. The neighbouring blocks of explicit parameters of very different illumination variations can in fact be considered as non-coherent with the current block. A weighted prediction parameter wp1 is similar to the weighted prediction parameter wp1_c of said current block when the norm, for example the absolute value, of the difference between the weighted prediction parameters is less than a threshold value c, i.e. |wp1−wp1_c|<ε.

During a step 24, first and second distortions are calculated. The first distortion D1 results from the prediction of a second causal neighbouring area Lc2 of the current block taking into account the implicit parameter wp2. The second distortion D1 results from the prediction, taking account of the explicit parameter wp1, of the second causal neighbouring area Lc2 of the current block.

Purely by way of example the distortions D1 and D2 are calculated as follows:

$${D}_{i} = {\sum }_{{L}_{c 2} , {L}_{r 2}}^{ } {( {I}_{c 2} - {I}_{p} ( {I}_{r 2} , {wp}_{i} ) )}^{2}$$

where:—i=1 or 2,
Ic2 represents the luminance values and/or chrominance values associated with the pixels of Lc2, Ir2 represents the luminance and/or chrominance values associated with the pixels of Lr2, Ip represents the luminance and/or chrominance values associated with the pixels of the prediction signal.

The second neighbouring area Lc2 of the current block is thus predicted using a second corresponding neighbouring area Lr2 of the reference block while taking account of the explicit prediction parameter respectively of the implicit prediction parameter. The first distortion respectively the second distortion is thus calculated between the prediction Ip and the second neighbouring area of the current block.

Ip is a function of Ir2 and wpi. Purely as an example, Ip=wpi*Ir2, in the case of a multiplicative weighted prediction parameter.

According to a variant,

$${D}_{i} = {\sum }_{{L}_{c 2} , {L}_{r 2}}^{ } \vert {I}_{c 2} - {I}_{p} ( {I}_{r 2} , {wp}_{i} ) \vert .$$

According to another variant, only the pixels of Lc2 (and thus Lr2) belonging to neighbouring blocks of the current block for which the implicit parameters of illumination variations are similar to those of the current block are taken into account in the calculation of distortions D1 and D2.

According to a preferred embodiment, the first causal neighbouring area Lc1 and the second causal neighbouring area Lc2 are separate, i.e. having no pixel in common.

According to another variant, the two neighbouring areas are different but not separate.

During a step 26, the first and second distortions are compared.

During a step 28, a weighted prediction parameter is selected according to the result of the comparison. For example, if a.D2 +b<D1, the parameter wp2 is selected otherwise wp1 is selected.

The parameters a and b are either predefined or determined according to the signal. For example, a and b are predefined as follows: a=1 and b=0. According to another example, a and b are determined according to the signal. Starting with the hypothesis according to which the parameters wp1 and wp2 are similar, it is then considered that the prediction signal by one or other implicit or explicit method corresponds to the signal of Lc2 to which is added a non-correlated Gaussian white noise of the same variance σ², i.e. Iₚ(Iᵣ₂, wpᵢ)=I_{c2}+e with e˜N(0,σ²), where N(0, σ²) is a normal distribution of null expectation and of variance σ². In this case, D1/σ² and D2/σ² are both distributed according to a distribution of χ² with the same degree of freedom n, n corresponding to the number of pixels of the neighbouring area Lc2 (or Lr2). D2/D1 then follows a Fischer distribution of n degrees of freedom. In this example, the parameter b is always null. The parameter will depend on the error rate that it is accorded (i.e. acceptance of the hypothesis though it is false) and on the number of samples of the neighbouring area Lc2. Typically, for an error rate of 5%, the following is obtained:
for n=8, a=3.44
for n=16, a=2.4
for n=32, a=1.85
for n=64, a=1.5

During a step 30, the current block is reconstructed according to a weighted prediction parameter selected in step 28. For example, if the explicit parameter is selected then B is reconstructed merging a residual block associated with Bc and a prediction block Bp where the prediction block is determined according to the reference block Br and the parameter wp1.

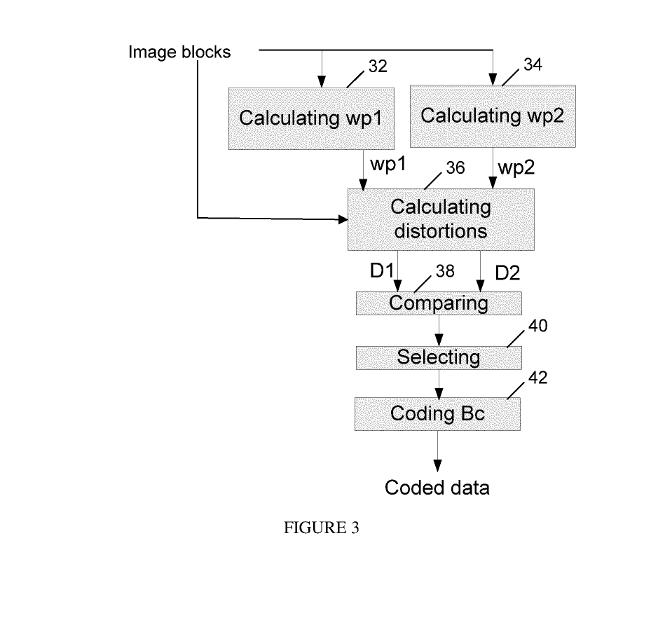

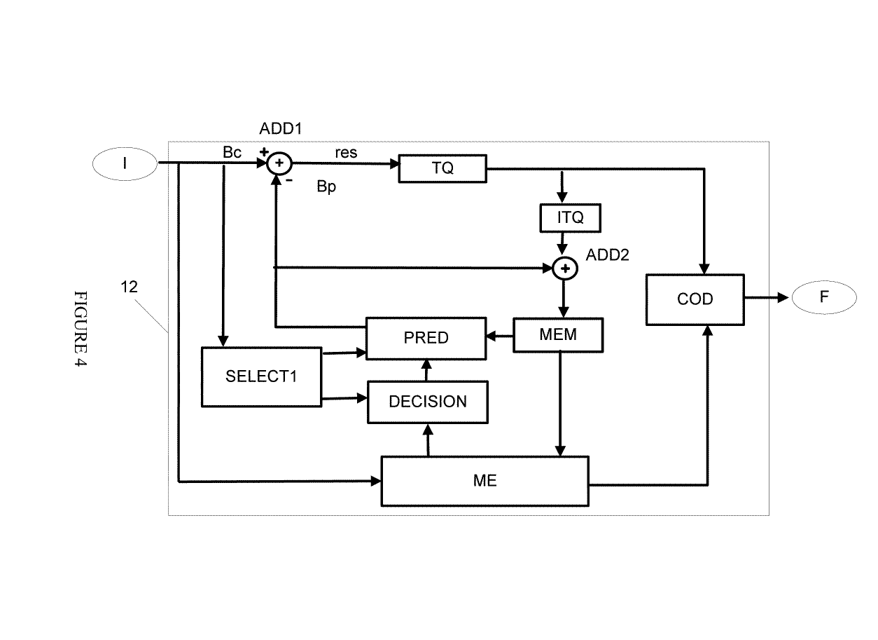

In reference to FIG. 3, the invention relates to a method for coding a current block Bc predicted from at least one reference block Br.

During a step 32, a weighted prediction parameter wp1, called the explicit parameter, is calculated. The explicit parameter is for example calculated using image data (luminance and/or chrominance) of the current block and image data of the reference block Br. Purely as an example, wp1 is equal to the average of luminance values associated with the pixels of Bc divided by the average of luminance values associated with the pixels of Br. This parameter, if it is selected, must be coded. In fact, the decoder when it reconstructs a current block Bc does not have available to it the image data of the current block and thus can not calculate wp1. It is for this reason that it is called explicit weighted prediction parameter. According to a variant, the parameter wp1 is systematically coded even in the case where it is not selected. It enables notably the neighbouring area Lc1 to be determined.

During a step 34, a weighted prediction parameter wp2, called the implicit parameter, is calculated from a first causal neighbouring area Lc1 of the current block Bc and a first corresponding neighbouring area Lr1 of the reference block Br. This parameter is determined according to a known method for example according to that described in the patent application WO/2007/094792 or according to the method described in the patent application WO/2010/086393.

According to a particular embodiment, the pixels of the first neighbouring area Lc1 (and consequently those of Lr1) are determined from the explicit parameter wp1. Note for example wp1_c the explicit parameter of the current block. Only the pixels of neighbouring blocks of Bc for which the explicit parameters wp1 are similar to that wp1_c of the current block are taken into account in Lc1. The neighbouring blocks of explicit parameters of very different illumination variations can in fact be considered as non-coherent with the current block. A weighted prediction parameter wp1 is similar to the weighted prediction parameter wp1_c of said current block when the norm, for example the absolute value, of the difference between the weighted prediction parameters is less than a threshold value c, i.e. |wp1−wp1_c|<ε.

During a step 36, first and second distortions are calculated. The first distortion D1 results from the prediction of a second causal neighbouring area Lc2 of the current block taking into account the implicit parameter wp2. The second distortion D1 results from the prediction, taking account of the explicit parameter wp1, of the second causal neighbouring area Lc2 of the current block.

Purely by way of example the distortions D1 and D2 are calculated as follows:

$${D}_{i} = {\sum }_{{L}_{c 2} , {L}_{r 2}}^{ } {( {I}_{c 2} - {I}_{p} ( {I}_{r 2} , {wp}_{i} ) )}^{2}$$

where:—i=1 or 2,
Ic2 represents the luminance values and/or chrominance values associated with the pixels of Lc2, Ir2 represents the luminance and/or chrominance values associated with the pixels of Lr2, Ip represents the luminance and/or chrominance values associated with the pixels of the prediction signal.

The second neighbouring area Lc2 of the current block is thus predicted using a second corresponding neighbouring area Lr2 of the reference block while taking account of the explicit prediction parameter respectively of the implicit prediction parameter. The first distortion respectively the second distortion is thus calculated between the prediction Ip and the second neighbouring area of the current block.

Ip is a function of Ir2 and wpi. Purely as an example, Ip=wpi*Ir2, in the case of a multiplicative weighted prediction parameter.

According to a variant,

$${D}_{i} = {\sum }_{{L}_{c 2} , {L}_{r 2}}^{ } \vert {I}_{c 2} - {I}_{p} ( {I}_{r 2} , {wp}_{i} ) \vert .$$

According to another variant, only the pixels of Lc2 (and thus Lr2) belonging to neighbouring blocks of the current block for which the implicit parameters of illumination variations are similar to those of the current block are taken into account in the calculation of distortions D1 and D2.

According to a preferred embodiment, the first causal neighbouring area Lc1 and the second causal neighbouring area Lc2 are separate.

According to another variant, the two neighbouring areas are different but not separate.

During a step 38, the first and second distortions are compared.

During a step 40, a weighted prediction parameter is selected according to the result of the comparison. For example, if a.D2+b<D1, the parameter wp2 is selected otherwise wp1 is selected.

The parameters a and b are either predefined or determined according to the signal. For example, a and b are predefined as follows: a=1 and b=0. According to another example, a and b are determined according to the signal. Starting with the hypothesis according to which the parameters wp1 and wp2 are similar, it is then considered that the prediction signal by one or other implicit or explicit method corresponds to the signal of Lc2 to which is added a non-correlated Gaussian white noise of the same variance σ², i.e. Iₚ(Iᵣ₂, wpᵢ)=I_{c2}+e with e˜N(0,σ²), where N(0, σ²) is a normal distribution of null expected value and of variance σ². In this case, D1/σ² and D2/σ² are both distributed according to a distribution of χ² the same degree of freedom n, n corresponding to the number of pixels of the neighbouring area Lc2 (or Lr2). D2/D1 then follows a Fischer distribution of n degrees of freedom. In this example, the parameter b is always null. The parameter will depend on the error rate that it is accorded (i.e. acceptance of the hypothesis though it is false) and on the number of samples of the neighbouring area Lc2. Typically, for an error rate of 5%, the following is obtained:
for n=8, a=3.44
for n=16, a=2.4
for n=32, a=1.85
for n=64, a=1.5

During a step 42, the current block Bc is coded according to the weighted prediction parameter selected in step 40. For example, if the explicit parameter wp1 is selected then Bc is coded by extracting from the current block Bc a prediction block Bp. The differential block or residual block thus obtained in then coded. The prediction block Bp is determined according to the reference block Br and the parameter wp1.

The invention further relates to a coding device 12 described with reference to FIG. 4. The coding device 12 receives at the input pictures I belonging to a sequence of pictures. Each image is divided into blocks of pixels each of which is associated with at least one item of image data, e.g. luminance and/or chrominance data. The coding device 12 notably implements a coding with temporal prediction. Only the modules of the coding device 12 relating to the coding by temporal prediction or INTER coding are shown in FIG. 12. Other modules not shown and known by those skilled in the art of video coders implement the INTRA coding with or without spatial prediction. The coding device 12 notably comprises a calculation module ADD1 capable of subtracting a prediction block Bp pixel by pixel from a current block Bc to generate a residual image data block or residual block noted res. It also comprises a module TQ able to transform then quantize the residual block res into quantized data. The transform T is for example a discrete cosine transform (or DCT). The coding device 12 further comprises an entropy coding module COD able to code the quantized data into a stream F of coded data. It also comprises a module ITQ implementing the inverse operation to the module TQ. The module ITQ implements an inverse quantization Q⁻¹ followed by an inverse transform T⁻¹. The module ITQ is connected to a calculation module ADD2 able to add pixel by pixel the block of data from the ITQ module and the prediction block Bp to generate a block of reconstructed image data that is stored in a memory MEM.

The coding device 12 further comprises a motion estimation module ME capable of estimating at least one motion vector between the block Bc and a block of a reference image Ir stored in the memory MEM, this image having previously been coded then reconstructed. According to a variant, the motion estimation can be carried out between the current block Bc and the original reference image Ic in which case the memory MEM is not connected to the motion estimation module ME. According to a method well known to those skilled in the art, the motion estimation module searches the reference picture Ir for a motion vector in such a manner as to minimize an error calculated between the current block Bc and a block in the reference image Ir identified by means of said motion vector. The motion data are transmitted by the motion estimation module ME to a decision module DECISION able to select a coding mode for the block Bc in a predefined set of coding modes. The coding mode retained is for example that which minimizes a bitrate-distortion type criterion. However, the invention is not restricted to this selection method and the mode retained can be selected according to another criterion for example an a priori type criterion. The coding mode selected by the decision module DECISION as well as the motion data, for example the motion vector(s) in the case of the temporal prediction mode or INTER mode are transmitted to a prediction module PRED. The motion vector(s) and the coding mode selected are also transmitted to the entropy coding module COD to be coded in the stream F. If an INTER prediction mode is retained by the decision module DECISION, the prediction module PRED then determines in the reference image Ir previously reconstructed and stored in the memory MEM, the prediction block Bp from the motion vector determined by the motion estimation module ME and the coding mode determined by the decision module DECISION. If an INTRA prediction mode is retained by the decision module DECISION, the prediction module PRED determines in the current image, from among the blocks previously coded and stored in the memory MEM, the prediction block Bp.

The prediction module PRED is able to determine the prediction block Bp taking into account a luminosity variation model defined by weighted prediction parameters representative of a luminosity variation between the images of the sequence or inside an image. For this purpose, the coding device 12 comprises a module for selection of weighted prediction parameters SELECT1. The selection module SELECT1 implements the steps 32 to 40 of the method described in reference to FIG. 3.

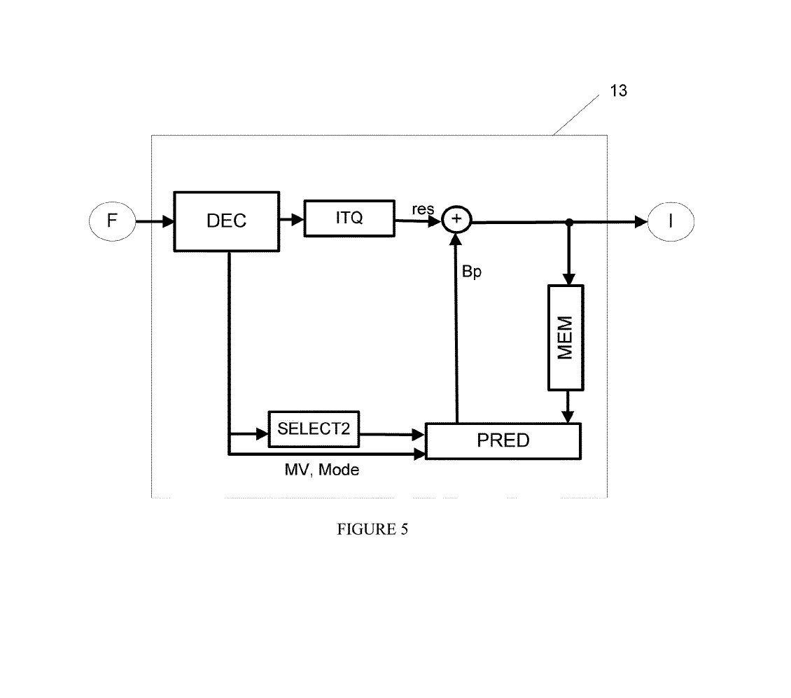

The invention further relates to a decoding device 13 described with reference to FIG. 5. The decoding device 13 receives at the input a stream F of coded data representative of a sequence of images. The stream F is for example transmitted by a coding device 12. The decoding device 13 comprises an entropy decoding module DEC able to generate decoded data, for example coding modes and decoded data relating to the content of images. The decoding device 13 also comprises a motion data reconstruction module. According to a first embodiment, the motion data reconstruction module is the entropy decoding module DEC that decodes a part of the stream F representative of said motion vectors.

According to a variant not shown in FIG. 5, the motion data reconstruction module is a motion estimation module. This solution for reconstructing motion data via the decoding device 13 is known as “template matching”.

The decoded data relating to the content of images is then transmitted to a module ITQ able to carry out an inverse quantization followed by an inverse transform. The ITQ module is identical to the ITQ module of the coding device 12 having generated the coded stream F. The ITQ module is connected to a calculation module ADD able to add pixel by pixel the block from the ITQ module and the prediction block Bp to generate a block of reconstructed image data that are stored in a memory MEM. The decoding device 13 also comprises a prediction module PRED identical to the prediction module PRED of the coding device 12. If an INTER prediction mode is decoded, the prediction module PRED determines in a reference image Ir previously reconstructed and stored in the memory MEM, the prediction block Bp from the motion vector MV and the coding mode decoded for the current block Bc by the entropy decoding module DEC. If an INTRA prediction mode is decoded, the prediction module PRED determines in the current image, from among the blocks previously reconstructed and stored in the memory MEM, the prediction block Bp.

The prediction module PRED is able to determine the prediction block Bp taking into account a luminosity variation model defined by weighted prediction parameters representative of a luminosity variation between the images of the sequence or inside an image. For this purpose, the decoding device 13 comprises a module for selection of weighted prediction parameters SELECT2. The selection module SELECT2 implements the steps 22 to 28 of the method for reconstruction described in reference to FIG. 2. Step 20 for decoding of wp1 is preferably implemented by the entropy decoding module DEC.

The methods for coding and for reconstruction are described for a parameter wp1 and a parameter wp2. However the invention can apply to a set of parameters J1 and set of parameters J2. J1 can thus comprise a multiplicative weighted parameter wp1 and an offset o1. The same applies to J2. More complex parameter sets can be implemented. The parameter sets are not necessarily the same.

The methods for coding and reconstruction are described for a single reference block Br. However, the invention can apply to a current block with which several reference blocks are associated (case of bi-directional prediction for example).

1. Method for reconstructing a current block of an image predicted from at least one reference block, said current block being in the form of coded data comprising steps for:
decoding at least one weighted prediction parameter, called an explicit parameter, from said coded data,
calculating at least one weighted prediction parameter, called an implicit parameter, from a first causal neighbouring area of said current block and a first corresponding neighbouring area of said reference block,
calculating a first distortion resulting from the prediction of a second causal neighbouring area of said current block with said explicit parameter and a second distortion resulting from the prediction of said second causal neighbouring area with said implicit parameter, said second causal neighbouring area being different from said first causal neighbouring area,
comparing said first and second distortions,
selecting one parameter between said explicit parameter and said implicit parameter according to the result of said comparison, and
reconstructing said current block using said selected parameter.

2. Method for reconstruction according to claim 1, wherein said first distortion respectively said second distortion is calculated according to the following steps:
predicting said second neighbouring area of the current block using a second corresponding neighbouring area of the reference block while taking account of said explicit prediction parameter respectively of said implicit prediction parameter, and
calculating said first distortion respectively said second distortion between said prediction and said second neighbouring area of the current block.

3. Method for reconstruction according to claim 1, wherein said first causal neighbouring area and said second causal neighbouring area are separate.

4. Method for reconstruction according to claim 1, wherein said first causal neighbouring area is determined by selecting pixels belonging to neighbouring blocks of said current block for which a difference between an explicit parameter of said neighbouring block and said explicit parameter of said current block is lower than a threshold.

5. Method for reconstruction according to claim 1, wherein said reference block belongs to the same image as the current block.

6. Method for reconstruction according to claim 1, wherein said reference block belongs to an image other than the image to which the current block belongs.

7. Method for coding a current block of an image sequence by prediction using at least one reference block comprising steps for:
calculating at least one weighted prediction parameter, called the explicit parameter, using the current block and the reference block,
calculating at least one weighted prediction parameter, called an implicit parameter, from a first causal neighbouring area of said current block and a first corresponding neighbouring area of said reference block,
calculating a first distortion resulting from the prediction of a second causal neighbouring area of said current block with said explicit parameter and a second distortion resulting from the prediction of said second causal neighbouring area with said implicit parameter, said second causal neighbouring area being different from said first causal neighbouring area,
comparing said first and second distortions, and
selecting a parameter between said explicit parameter and said implicit parameter according to the result of said comparison, and
coding said current block using said selected parameter.

8. Method for coding according to claim 7, wherein said explicit parameter is coded.

9. Device for decoding coded data to reconstruct a current block of an image predicted from at least one reference block comprising:
a module configured to decode at least one weighted prediction parameter, called an explicit parameter, from said coded data,
a module configured to calculate at least one weighted prediction parameter, called an implicit parameter, from a first causal neighbouring area of said current block and a first corresponding neighbouring area of said reference block,
a module configured to calculate a first distortion resulting from the prediction of a second causal neighbouring area of said current block with said explicit parameter and a second distortion resulting from the prediction of said second causal neighbouring area with said implicit parameter, said second causal neighbouring area being different from said first causal neighbouring area,
a module configured to compare said first and second distortions,
a module configured to select one parameter between said explicit parameter and said implicit parameter according to the result of said comparison, and
a module configured to reconstruct said current block using said selected parameter.

10. Device for coding a current block of an image sequence by prediction using at least one reference block comprising:
a module configured to calculate at least one weighted prediction parameter, called the explicit parameter, using the current block and the reference block,
a module configured to calculate at least one weighted prediction parameter, called an implicit parameter, from a first causal neighbouring area of said current block and a first corresponding neighbouring area of said reference block,
a module configured to calculate a first distortion resulting from the prediction of a second causal neighbouring area of said current block with said explicit parameter and a second distortion resulting from the prediction of said second causal neighbouring area with said implicit parameter, said second causal neighbouring area being different from said first causal neighbouring area,
a module configured to compare said first and second distortions,
a module configured to select a parameter between said explicit parameter and said implicit parameter according to the result of said comparison, and
a module configured to code said current block using said selected parameter.

11. Method for coding according to claim 7, wherein said first causal neighbouring area and said second causal neighbouring area are separate.

12. Method for coding according to claim 7, wherein said first causal neighbouring area is determined by selecting pixels belonging to neighbouring blocks of said current block for which a difference between an explicit parameter of said neighbouring block and said explicit parameter of said current block is lower than a threshold.

13. A non-transitory program storage device, readable by a computer, tangibly embodying a program of instructions executable by the computer to perform a method comprising the steps of:
decoding at least one weighted prediction parameter, called an explicit parameter, from said coded data,
calculating at least one weighted prediction parameter, called an implicit parameter, from a first causal neighbouring area of said current block and a first corresponding neighbouring area of said reference block,
calculating a first distortion resulting from the prediction of a second causal neighbouring area of said current block with said explicit parameter and a second distortion resulting from the prediction of said second causal neighbouring area with said implicit parameter, said second causal neighbouring area being different from said first causal neighbouring area,
comparing said first and second distortions,
selecting one parameter between said explicit parameter and said implicit parameter according to the result of said comparison, and
reconstructing said current block using said selected parameter.

14. A non-transitory program storage device, readable by a computer, tangibly embodying a program of instructions executable by the computer to perform a method comprising the steps of:
calculating at least one weighted prediction parameter, called the explicit parameter, using the current block and the reference block,
calculating at least one weighted prediction parameter, called an implicit parameter, from a first causal neighbouring area of said current block and a first corresponding neighbouring area of said reference block,
calculating a first distortion resulting from the prediction of a second causal neighbouring area of said current block with said explicit parameter and a second distortion resulting from the prediction of said second causal neighbouring area with said implicit parameter, said second causal neighbouring area being different from said first causal neighbouring area,
comparing said first and second distortions, and
selecting a parameter between said explicit parameter and said implicit parameter according to the result of said comparison, and
coding said current block using said selected parameter.
